(19) United States
(12) Patent Application Publication
(10) Pub. No.: US 2003/0181113 A1
(43) Pub. Date: Sep. 25, 2003

(54) Release barrier fabrics

(76) Inventors: Roy P. Demott, Spartanburg, SC (US); William C. Kimbrell, Spartanburg, SC (US); Thomas E. Godfrey, Moore, SC (US); Samuel J. Lynn, Greenwood, SC (US)

Correspondence Address: Jeffery E. Bacon, Legal Department, M-495, PO Box 1926, Spartanburg, SC, 29304, US

(21) Appl. No.: 10/365,591

(22) Filed: Feb. 12, 2003

Related U.S. Application Data
(63) Continuation of application No. 09/864,461, filed on May 23, 2001, now abandoned.
Application No. 09/864,461 is a continuation-in-part of application No. 09/625,474, filed on Jul. 25, 2000, now Pat. No. 6,541,402.
Application No. 09/625,474 is a continuation of application No. 09/286,797, filed on Apr. 6, 1999, now Pat. No. 6,136,730.
Application No. 09/286,797 is a continuation-in-part of application No. 08/799,790, filed on Feb. 12, 1997, now Pat. No. 5,899,783.

(51) Int. Cl. B32B 5/18; B32B 5/22

(52) U.S. Cl. 442/76

(57) ABSTRACT

A woven fabric substrate is treated with a fluorochemical stain resist agent and thereafter extrusion coated substantially on the back side with a layer of thermoplastic polymeric material so as to yield a final construction which exhibits both fluid and stain resistant properties. The fabric substrate can also be treated with an flame retardant agent, an antistatic agent, and/or an anti-microbial agent.

### CROSS-REFERENCE TO RELATED APPLICATIONS

This application is a continuation of U.S. patent application Ser. No. 09/864,461, filed on May 23, 2001, which is a continuation-in-part of U.S. patent application Ser. No. 09/625,474, filed on Jul. 25, 2000, which is continuation of U.S. patent application Ser. No. 09/286,797, which was filed on Apr. 6, 1999, and issued on Oct. 24, 2000, to Kimbrell, Jr. et al. as U.S. Pat. No. 6,136,730, which is a continuation-in-part of U.S. patent application Ser. No. 08/799,790, which was filed on Feb. 12, 1997, and issued on May 4, 1999, to Kimbrell, Jr. et al. as U.S. Pat. No. 5,899,783. These references are all hereby incorporated herein in their entirety by specific reference thereto.

### BACKGROUND

Traditional cars, which are typically used for family type transportation, require an interior fabric that has pleasing aesthetics. Traditional trucks and sport utility vehicles, which are typically used for industrial work and weekend outdoor sports activities, require an interior fabric that is durable to abrasion and extensive use, and that resists soiling and water. Recent trends have been to use a hybrid of traditional cars, trucks, and sport utility vehicles. The hybrid transportation vehicles are used not only for the family type transportation, but also for industrial and outdoor sport activities of the traditional trucks and sport utility vehicles. Additionally, fabrics for use in transportation vehicles must meet stringent requirements, such as flame resistance. Therefore, there is a need for textiles to be used in the interior of transportation vehicles, that not only have the pleasing aesthetics necessary for traditional cars but also the durability and soil and water resistance of the traditional sport utility vehicle.

Heretofore, a number of approaches have been taken to making fabrics both cleanable and liquid resistant so as to be more useful in environments where liquid staining is likely to occur. Vinyl coated fabrics have been most broadly accepted for these purposes due to relatively easy cleanability and fairly low cost. However, such vinyl coated fabrics are typically rather stiff to the touch and thereby lack the desired appearance and feel for use in environments such as automobiles, restaurants, nursing homes, and the like where pleasing tactile and visual perceptions by the user are considered important. Surface laminated fabrics have been utilized to enhance the aesthetic characteristics of the fabrics, but due to the generally disjunctive adherence between the laminate film and the fabric itself, these products tend to peel, crack, and delaminate after long periods of use. Such laminated products also tend to lack the generally desirable feel of standard upholstery products. Additionally, adherence of a liquid barrier film or coating to a fabric substrate is made all the more difficult when fluorochemical stain-resist treatments are applied, since such compositions by their nature tend to repel an applied coating. Therefore, there is a need for fabrics that are both cleanable and liquid resistant.

### OBJECTS AND SUMMARY OF THE INVENTION

In light of the foregoing, it is a general object of the present invention to provide a fabric which can be used in transportation vehicles, which has pleasing aesthetics for family type transportation and the durability and soil and water resistance necessary for the traditional sporty utility vehicle.

It is another object of the present invention to provide a fabric which possesses both stain resist and fluid barrier properties but which also exhibits a soft fabric hand as in traditional untreated upholstery fabrics where a soft fabric hand is understood to mean flexibility and/or lack of stiffness in the fabric itself.

It is yet another object of the present invention is to provide a fabric wherein a barrier coating of thermoplastic polymeric material including elastomeric components is adhered in stable relation to a fluorochemically treated surface.

Yet another object of the present invention to provide a fluid shield fabric useful in upholstery applications possessing a barrier coating of thermoplastic polymeric material in stable relation to a fluorochemically treated surface of a woven, knitted, or nonwoven fabric substrate.

Yet another object of this invention is to provide an aesthetically pleasing woven fabric possessing the same characteristics described above and also exhibiting a certain resistance to chlorine bleach dye removal.

Yet another object of this invention is to provide an aesthetically pleasing barrier fabric possessing the ultraviolet fading resistance and flame resistance necessary for application in a vehicle.

Other objects, advantages and features of the present invention will, no doubt, occur to those skilled in the art upon reading of the following specification. Thus, while the invention will be described and disclosed in connection with certain preferred embodiments and procedures, it is by no means intended to limit the invention to such specific embodiments and procedures. Rather, it is intended to cover all such alternative embodiments, procedures, and modifications thereto as may fall within the true spirit and scope of the invention as defined only by the appended claims and equivalents thereto.

### DETAILED DESCRIPTION

The present invention relates to a textile that can be used in a transportation vehicle and that has pleasing aesthetics, resists soiling and water, provides a fluid barrier, cleans easily, and is durable to abrasion and extensive use. The textile of the present invention is preferably not effected when washed, or wet-vacuumed to clean difficult stains.

In one embodiment, the textile of the present invention is release barrier fabric having a fabric substrate chemically treated with a low surface energy stain resist compound, such as a fluorochemical, and also having a polymer barrier coating. The release barrier fabric of the present invention exhibits a resistance to fading or degradation due to ultraviolet (UV) exposure. The light fastness properties of the release barrier can be accomplished by disposing a UV inhibitor over the fabric substrate, or by selecting a yarn that possess light fastness properties, such as solution dyed yarns. In a potentially preferred practice of the present invention, a woven fabric substrate is treated with a fluorochemical stain resist agent and thereafter extrusion coated substantially on the back side with a layer of thermoplastic polymeric material so as to yield a final construction which exhibits both fluid and stain resistant properties. In a further embodiment, the fabric substrate can also be treated with an flame retardant agent, an antistatic agent, and/or an anti-microbial agent.

The release barrier fabric of the present invention exhibits a good hand while maintaining intimate adhesion between the base fabric and the polymeric barrier material, despite the use of an intermediate fluorochemical composition. The present invention overcomes these seemingly contradicting requirements of low energy stain resistance in combination with a strongly adherent fluid barrier shield through proper selection of the base textile material in combination. The present invention therefore represents a useful advancement over present practices.

In one embodiment, the fabric substrate is a woven material, although it is contemplated that tightly formed knitted materials and/or nonwovens as are known to those of skill in the art may likewise be used if desired. The woven fabric may be woven in any type of pattern, such as Jacquard, for example. The fabric substrate will have a first side and a second side.

In one embodiment, the fabric substrate is formed from solution dyed polyester yarns, although it is contemplated that other materials including, by way of example only and not limitation, cotton-polyester blends, nylon fibers, other polyester yarns, polypropylene, acrylics, or mixtures thereof may also be utilized. In one embodiment, it has been found that the use of hairy type yarn in a woven fabric substrate permits good adhesion between the fabric substrate and the polymeric material, despite the occurrence of the fluorochemical stain resist agent when extrusion coating is used to force the polymeric material into the woven fabric substrate, thereby effectively surrounding and covering such yarn. One type of yarn that has been found to be useful in the present invention is an Albi-type textured yarn. It is to be understood that by the term Albi-type textured yarn, what is meant is a textured yarn having a hairy surface made up of a number of fibrils.

In one embodiment, the fabric substrate is a colored fabric, which means that the color of the fabric has an L value of about 93 or less. It is preferred that the yarn forming the fabric substrate be solution dyed yarn. In one embodiment, it has been found that the use of solution dyed polyester provides the light fastness, hand, and recyclability desired for use in automobiles. In another embodiment, it has been found that the use of solution dyed nylon yarn in a woven fabric substrate provides excellent prevention of discoloration due to chlorine bleach exposure, no matter what type of polymeric material is utilized as a barrier layer. However, the present invention contemplates other methods of dyeing the fabric and/or yarn, such as piece dyeing, yarn dyeing, package dyeing, thermasol dyeing, printing, or the like.

The fabric substrate can be scoured before the dyeing process, and/or after the dyeing process. In one embodiment, the fabric substrate ins scoured, heat set, and passed through a jet dyeing machine so as to close the interstices between the individual yarns while at the same time enhancing the hairness thereof. The jet dyeing treatment can be performed with dye molecules present, although the dye molecules could be excluded if no coloration was desired, or if the fabric contained a coloration due to the use of solution dyed yarns or the like.

The ultraviolet (UV) resist agent can be placed onto at least the first side of the fabric substrate. The UV resist agent can be placed onto the first side of the fabric substrate by spraying, foam application, kiss-coat, or the like, or on both sides of the fabric substrate by immersion coating, padding, or the like. The UV resist agent can be placed on the fabric substrate with the low surface energy stain resist compound, or in a separate step with, or without, the other agents disposed on the fabric substrate. Suitable UV resist agents can include benzotriazoles, modified triazine, or the like.

The flame retardant agent can be placed onto at least the first side of the fabric substrate, or be incorporated into the material of the yarn prior to forming the fabric substrate. The flame retardant agent can be placed onto the first side of the fabric substrate by spraying, foam application, kiss-coating, or the like, or on both sides of the fabric substrate by immersion coating, padding, or the like. The flame retardant agent can be placed on the fabric substrate with the low surface energy stain resist compound, or in a separate step with, or without, the other agents disposed on the fabric substrate. Suitable flame retardant agents can include therein cyclic phoshonate, halogenated parafin, brominated cyclic, or the like.

The anitmicrobial agent can be placed onto at least the first side of the fabric substrate. The antimicrobial agent can be placed onto the first side of the fabric substrate by spraying, foam application, kiss-coat, or the like, or on both sides of the fabric substrate by immersion coating, padding, or the like. The antimicrobial agent can also be placed on the fabric substrate by exhausting the antimicrobial onto the fabric during the dye cycle. Additionally, the antimicrobial can be incorporated into the fibers forming the fabric substrate. Suitable antimicrobials include, but are not limited to, silver, silicon quat, triclosan, and organotin. The antimicrobial can be applied at the effectice minimum inhibiting concentration, such as at a level of 1.00% of DM-50.

The antistatic agent can be placed onto at least the first side of the fabric substrate. The antistatic agent can be placed onto the first side of the fabric substrate by spraying, foam application, kiss-coat, or the like, or on both sides of the fabric substrate by immersion coating, padding, or the like. The antistatic agent can be placed on the fabric substrate with the low surface energy stain resist compound, or in a separate step with, or without, the other agents disposed on the fabric substrate. Suitable antistatic agents can include highly ethoxylated esters, quartenery ammonium compounds, or the like.

The low surface energy stain resist compound is applied to at least the first side of the substrate fabric. The low surface energy stain resist compound can be placed onto the first side of the fabric substrate by spraying, foam application, kiss-coat, or the like, or on both sides of the fabric substrate by immersion coating, padding, or the like. A preferred low surface energy stain resist compound is a fluorochemical, and more preferred is a highly durable, highly water and oil repellent fluorochemical.

In one embodiment, the polymer barrier coating is applied to the second side of the fabric substrate. The polymer coating provides a liquid barrier to protect materials, such as foam cushions, from the intrusion of liquids located on the opposite side of the textile from the material to be protected. It is believed that it is the intimate contact over a relatively large effective surface area as provided by the extrusion coating practice which permits the substantial physical adherence of the coating to the substrate even at low levels of polymer application. In one embodiment, the selection of coating materials and application processes are selected so as to permit a very thin layer of barrier material to be applied. In one embodiment, the coating material is less than about 0.010 inches thick. In another embodiment, the coating material is less than about 0.005 inches thick. In yet another embodiment, the coating material is between about 0.0005 inches thick and about 0.002 inches thick. Moreover, the actual material making up this barrier layer preferably possess elastomeric properties which tend to conform substantially to those of the fabric substrate.

It has been found that through use of a polymeric material which includes an elastomeric component therein, high degrees of flexibility can be achieved without the occurrence of delamination. Also, such polymeric materials must be able to withstand possible dissolution when in contact with cleaning solvents and compositions associated with fabric care (such as isopropyl alcohol, acetone, mineral spirits, and the like), must exhibit suitable viscosity for ease in manufacturing of the target fabric, and must possess hydrostatic capability to perform well as a barrier layer. Coating materials which may be used include by way of example only, acrylate polymers (such as methacrylate polymers), polyurethanes, polypropylene compositions, PET polyester compositions, polybutylene terephthalete (PBT) polyester compositions, elastomeric polyethylene, and metallocene polyethylene compositions. The invention may be further understood and illustrated through reference to the following non limiting examples. In one embodiment of the invention, polyurethanes and acrylate polymers are utilized as the polymeric material. In yet another embodiment, extruded methacrylate (ethylene methyl acrylate, for instance) is used for the polymeric material.

It is contemplated that additional performance enhancing constituents may be incorporated within the thermoplastic polymeric materials which are extrusion coated onto the fabric substrate. These performance enhancing constituents may include, by way of example only and not limitation, antimicrobial compositions, flame retardants, antistats, and/or ultraviolet stabilizing agents such as are known to those of skill in the art.

The polymer barrier coating can be applied by extrusion coating the polymer material onto the second side of the fabric substrate. The polymer coating can be applied before the application of the low surface energy stain resist compound, UV resist agent, antimicrobial agent, and/or the antistatic agent, however, it is preferred to apply the polymer coating after application of these agents to avoid the degradation of the coating that might occur should the fabric need a high temperature drying or curing process after application of the agents. As will be appreciated by those of skill in the art, extrusion coating typically involves the process of extruding a molten film from a die and contacting this molten film with the fabric substrate under pressure in the nip of two counter-rotating rolls. In the preferred practice, one of these rolls is a chill roll which is in contact with the surface being coated while the other roll is a deformable rubber material which is in contact with the side remaining uncoated. Through the use of such a configuration, a layer of molten polymer material is spread across and forced at least partially into the fabric substrate which has been treated with the low surface energy stain resist compound. This operation leads to a configuration wherein the polymer barrier coating substantially covers and surrounds the yarn or fibers of the fabric over a large surface area so as to promote good mechanical adhesion. In addition, the material of the polymer barrier coating is pressed at least partially into the interstices between the individual yarns or fibers of the fabric, so as to provide a barrier to fluid passage therebetween.

In one embodiment, a layer of foam is secured to the release barrier fabric. The foam can be a polyurethane foam that is laminated or bonded to the surface of the release barrier fabric having the polymer barrier. Lamination can be accomplished by flame lamination or the like. Bonding can be accomplished by an adhesive or other bonding materials and methods.

As used herein, the fluid barrier properties are determined by the American Association of Textile Chemists and Colorists (AATCC) Water Resistance: Hydrostatic Pressure Test Method 127-1998, Water Repellency: Spray Test Method 22-1996, and Water Resistance: Rain Test Method 35-2000, which are all hereby incorporated herein in their entirety by specific reference thereto. The release barrier fabric of the present invention has a hydrostatic pressure resistance of about 50 millibars or greater as determined by AATCC Water Resistance: Hydrostatic Pressure Test TM 127-1998. The release barrier fabric of the present invention has a water repellency rating of about 70 (IS04) or greater, as determined by the AATCC Water Repellency: Spray Test TM 22-1996. The release barrier fabric of the present invention has a water resistance of an average value equal to, or less than, about 2 grams, as determined by the AATCC Water Resistance: Rain Test TM 35-1994.

As used herein, the stain resistance properties are determined by AATCC Oil Repellency: Hydrocarbon Resistance Test Method 118-1997, which is hereby incorporated herein in its entirety by specific reference thereto. The stain resistance of the release barrier fabric of the present invention is about a Grade 3 or greater, as determined by the AATCC Oil Repellency: Hydrocarbon Resistance Test TM 118-1997.

As used herein, the cleanablity properties are determined by the BFTB-402 Test Methods, which is hereby incorporated herein in its entirety by specific reference thereto. The cleanablility of the release barrier fabric of the present invention is about a Class 3 or greater, as determined by the BFTB-402 Test Method.

As used herein, the antimicrobial properties are determined by the American Society for Testing and Materials (ASTM) G 21-96 Standard Practice for Determining Resistance of Synthetic Polymeric Materials to Fungi, which is hereby incorporated herein in its entirety by specific reference thereto. The antimicrobial properties of the release barrier fabric of the present invention is about a 1 or less, as determined by ASTM G21-96.

As used herein, the UV resistance properties are determined by SAE Recommended Practice SAE J1885 MAR92, Accelerated Exposure of Automotive Interior Trim Components Using A Controlled Irradiance Water Cooled Xenon-Arc Apparatus, which is hereby incorporated herein in its entirety by specific reference thereto. The UV resistance of the release barrier fabric of the present invention demonstrates a Eof about 4.0 or less at 225 kj, as determined by SAE J1885 MAR92.

As used herein, the thermal shock properties are determined by heating a fabric sample to about 100° C., applying the sample to a simulated body of predominately water at about 98° F., and measuring the temperature at the interface between the fabric sample and the simulated body after one second. The sample is approximately a 325 square inch piece of fabric mounted to a 3 mm thick polyurethane foam backing. The simulated body is approximately 25 pounds of water with an agar gel stabilizer, contained in a plastic bag. The temperature at the interface is measured by placing a thermocouple on the surface of the plastic bag. The release barrier fabric of the present invention experienced temperatures of about 35° C. or less after one second of contact with the simulated body.

As used herein, the flame resistance properties are determined by SAE Standard SAE J365 JAN92, Flameablility of Polymeric Interior Materials Horizontal Test Method, which is hereby incorporated herein in its entirety by specific reference thereto. The flame resistance properties of the release barrier fabric of the present invention is about 100 mm/minute or less, as determined SAE J365 JAN92.

As used herein, the crocking properties are determined by AATCC Colorfastness to Crocking: MTCC Crockmeter Method TM 8-1996, which is hereby incorporated herein in its entirety by specific reference thereto. The crocking resistance of the release barrier fabric of the present invention is about a 3 or greater, as determined by the AATCC Colorfastness to Crocking: AATCC Crockmeter Method TM 8-1996.

As used herein, the antistatic properties are determined by AATCC Electrical Resistivity of Fabrics Test Method TM 76-1978, which is hereby incorporated herein in its entirety by specific reference thereto. The antistatic properties of the release barrier fabric of the present invention is about 10¹² ohms per square or less, and preferably between about 10¹⁰ and about 10¹² ohms per square, as determined by the AATCC Electrical Resistivity of Fabrics Test Method TM 76-1978.

What is claimed is:

1. An article comprising:
a colored fabric substrate having a first side and a second side;
a liquid impermeable back coating on the second side of the substrate;
a low surface energy stain resist compound disposed on at least the first side of the substrate; and
a UV inhibitor disposed on at least the first side of the substrate.

2. An article comprising a colored textile, said article having:
a hydrostatic liquid resistance of 50 millibars or greater;
a spray resistance of 70 or greater;
a rain resistance of 2 grams or less; and
a Eof 4.0 or less when subjected to 225 kj.
